(19) United States
(12) Patent Application Publication
(10) Pub. No.: US 2020/0307791 A1
(43) Pub. Date: Oct. 1, 2020

(54) SPREADING APPARATUS, CONTROL METHOD THEREFOR, AND PLANT PROTECTION UNMANNED AERIAL VEHICLE

(71) Applicant: SZ DJI TECHNOLOGY CO., LTD., Shenzhen (CN)

(72) Inventors: Zhuang FENG, Shenzhen (CN); Zijing CHANG, Shenzhen (CN)

(21) Appl. No.: 16/898,148

(22) Filed: Jun. 10, 2020

Related U.S. Application Data
(63) Continuation of application No. PCT/CN2017/117002, filed on Dec. 18, 2017.

(51) Int. Cl. B64D 1/16; B64C 39/02; A01M 7/00; A01M 9/00

(52) U.S. Cl. CPC B64D 1/16; B64C 39/024; A01M 7/0089; B64C 2201/146; B64C 2201/027; B64C 2201/12; A01M 9/0092

(57) ABSTRACT

A method for controlling a spreading apparatus includes obtaining a target degree of opening and a real-time degree of opening of a material outlet of the spreading apparatus, determining whether the real-time degree of opening of the material outlet is abnormal based on a comparison result between the real-time degree of opening and the target degree of opening, and transmitting an alarm signal to a remote control device in response to the real-time degree of opening of the material outlet being abnormal.

### CROSS-REFERENCE TO RELATED APPLICATION

This application is a continuation of International Application No. PCT/CN2017/117002, filed Dec. 18, 2017, the entire content of which is incorporated herein by reference.

### TECHNICAL FIELD

The present disclosure relates to the control of material spreading for plant protection unmanned aerial vehicle, and more particularly, to a spreading apparatus control method, a device, and a plant protection unmanned aerial vehicle.

### BACKGROUND

A plant protection unmanned aerial vehicle is an unmanned aerial vehicle (UAV) for agricultural and forestry plant protection operations. This type of UAV can achieve long-distance remote control operations, and can also avoid issues such as manual labor with high labor intensity, low efficiency, and low spreading density uniformity, etc., and hence has become more and more popular with agricultural producers.

In existing technologies, a plant protection unmanned aerial vehicle includes a flight platform (e.g., fixed wing, helicopter, multi-axis aircraft), and a spreading apparatus disposed below the flight platform. The plant protection unmanned aerial vehicle performs the spreading operation of solid particles such as seeds, chemicals, fertilizers, etc., through ground remote control or navigation flight control of the flight platform. The spreading apparatus capable of spreading solid particles generally includes a material box, a stirring mechanism provided in the material box, a discharge adjustment mechanism provided in the material box, and a spreading mechanism provided below a leak. The stirring mechanism includes a ducted fan and a duct housing coaxial with the material box. The air outlet of the duct housing faces above the base plate of the material box, so that the material in the material box can be stirred by the ducted fan. The discharge adjusting component includes a switch baffle provided at the leak, a steering gear, and a connecting rod connecting the steering gear arm and the switch baffle. The opening can be adjusted by moving the switch baffle on the leak through the steering gear and the connecting rod. The spreading mechanism includes a side plate connected to the bottom of the material box, a roulette motor, and a roulette connected to the roulette motor. The roulette is disposed at the inner side of the side plate, and a spreading port is provided at the side plate, so that the roulette motor drives the roulette to rotate, and hence eject the material falling from the leak to the roulette from the spreading port.

During the operation, the plant protection unmanned aerial vehicle is started first and hovers after flying to a certain height. The roulette motor, the ducted fan, and the steering gear are then started to perform the spreading of the solid particles. In the actual operation process, the solid particles block the leak or the discharge adjustment mechanism has a mechanical failure sometimes, which may cause the degree of opening of the switch baffle to be inconsistent with the target degree of opening, and hence cause uneven spreading.

### SUMMARY

In accordance with the disclosure, there is provided a method for controlling a spreading apparatus including obtaining a target degree of opening and a real-time degree of opening of a material outlet of the spreading apparatus, determining whether the real-time degree of opening of the material outlet is abnormal based on a comparison result between the real-time degree of opening and the target degree of opening, and transmitting an alarm signal to a remote control device in response to the real-time degree of opening of the material outlet being abnormal.

Also in accordance with the disclosure, there is provided a spreading apparatus including a material box including a material outlet at bottom, an opening adjustment mechanism including a baffle plate provided at the material outlet and a baffle plate motor configured to drive the baffle plate to move to adjust a degree of opening of the material outlet, a spreading mechanism including a turntable provided below the baffle plate and a turntable motor configured to drive the turntable to rotate, and a processor configured to obtain a target degree of opening and a real-time degree of opening of the material outlet, determine whether the real-time degree of opening of the material outlet is abnormal based on a comparison result between the real-time degree of opening and the target degree of opening, and transmit an alarm signal to a remote control device in response to the real-time degree of opening of the material outlet being abnormal.

Also in accordance with the disclosure, there is provided a plant protection unmanned aerial vehicle including a body, an arm with one end connected with the body, a power assembly arranged at another end of the arm, and a spreading apparatus carried below the body. The spreading apparatus includes a material box including a material outlet at bottom, an opening adjustment mechanism including a baffle plate provided at the material outlet and a baffle plate motor configured to drive the baffle plate to move to adjust a degree of opening of the material outlet, a spreading mechanism including a turntable provided below the baffle plate and a turntable motor configured to drive the turntable to rotate, and a processor configured to obtain a target degree of opening and a real-time degree of opening of the material outlet, determine whether the real-time degree of opening of the material outlet is abnormal based on a comparison result between the real-time degree of opening and the target degree of opening, and transmit an alarm signal to a remote control device in response to the real-time degree of opening of the material outlet being abnormal.

### BRIEF DESCRIPTION OF THE DRAWINGS

FIG. 1 is a front view of a plant protection unmanned aerial vehicle according to one embodiment of the present disclosure.

FIG. 2 is a side view of a plant protection unmanned aerial vehicle according to one embodiment of the present disclosure.

FIG. 3 is a schematic structural diagram of a spreading apparatus of a plant protection unmanned aerial vehicle according to one embodiment of the present disclosure.

FIG. 4 is a schematic structural diagram of an opening adjustment mechanism and a turntable of the spreading mechanism in FIG. 3.

FIG. 5 is a schematic flowchart of a method for controlling a spreading apparatus according to one embodiment of the present disclosure.

FIG. 6 is a schematic flowchart of controlling the spreading operation of a plant protection unmanned aerial vehicle according to one embodiment of the present disclosure.

### REFERENCE NUMERALS

10—Body
30—Arm
50—Power assembly
70—Spreading apparatus
701—Material box
703—Opening adjustment mechanism
7031—Steering gear
7033—Transmission gear
7035—Baffle plate
705—Spreading mechanism
7051—Turntable
707—Stirring mechanism
90—Stand

### DETAILED DESCRIPTION OF THE EMBODIMENTS

Technical solutions of the present disclosure will be described in detail with reference to the drawings. In the case of no conflict, the features of the following examples and implementations can be combined with each other. In the case of no particular limitation or if not contrary to the purpose of the disclosure, the order of steps is arbitrary.

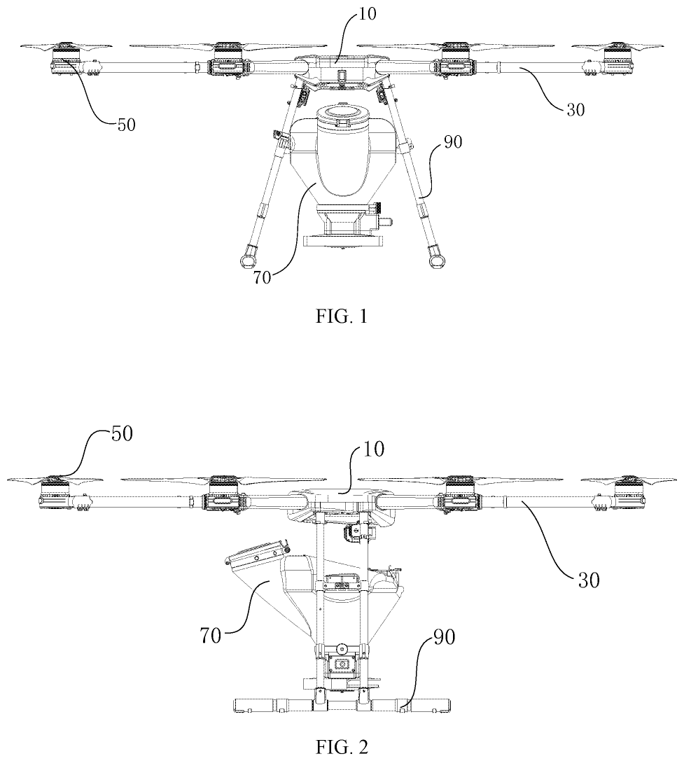

FIGS. 1 and 2 are a front view and a side view of a plant protection unmanned aerial vehicle consistent with embodiments of the present disclosure.

As shown in FIG. 1 and FIG. 2, the plant protection unmanned aerial vehicle includes a body 10, an arm 30, a power assembly 50, and a spreading apparatus 70 carried below the body 10.

The body 10 includes a casing and a flight controller provided in the casing. The casing can be made of plastic or metal materials and include a top plate, a bottom plate, and a side wall. The top end of the side wall is fixed to the top plate, and the bottom end is fixed to the bottom plate. The side wall, the top plate, and the bottom plate enclose to form a mounting space for accommodating the flight controller. The shapes of the top plate and the bottom plate can be any geometric shapes, e.g., rectangle, circle, oval, pentagon, hexagon, etc., and the area of the top plate can be greater than, equal to, or smaller than the area of the bottom plate. The side wall can be a whole board, or it can be formed by splicing a plurality of boards. In some embodiments, a power source (e.g., a lithium battery including a plurality of cells) is provided in the casing or in a groove formed by an inward depression of the bottom plate. The spreading apparatus 70 is disposed below the bottom plate, and can be fixed to the bottom plate by, e.g., a connection member (e.g., a clip or a bolt). When a stand 90 is provided below the bottom plate to support the body 10 during landing, the spreading apparatus 70 may be fixed on the stand 90 through a connection member (e.g., a clip).

One end of the arm 30 is fixed to the body 10, and the other end is configured to mount the power assembly 50. The arm 30 may be a hollow tubular member with a circular, oval or other suitable shape in cross section, and be made of plastic, metal, or carbon fiber, etc. The number of the arm 30 may be one or more. For example, when only one arm 30 is provided, the bottom end of the arm 30 may be fixed on the top plate of the body 10 to form a helicopter-type plant protection unmanned aerial vehicle. When more than one arm 30 is provided, the more than one arm 30 may extend outward from the body 10 in a radial manner, thereby forming a multi-rotor plant protection unmanned aerial vehicle. In some embodiments, the more than one arm 30 extending radially outward from the body 10 may be designed to be foldable relative to the body 10, thereby reducing the volume occupied by the plant protection unmanned aerial vehicle during storage and transportation.

The power assembly 50 includes a propeller, a motor for driving the propeller to rotate to generate a pulling force, and an electronic speed control (ESC) for controlling operation parameters of the motor (e.g., speed, steering, acceleration, etc.) In a multi-rotor plant protection unmanned aerial vehicle according to some embodiments, the arm 30 is provided with a mounting base at an end distal from the body 10. The propeller is fixed on the top of the mounting base, and the motor is fixed inside the mounting base. The electronic speed control is provided at the bottom of the mounting base and connected to the flight controller and power supply through communication and power cables. In some embodiments, the electronic speed control can also be provided in the cavity of the arm 30 or in the casing of the body 10 and connected to the motor through a communication cable. When the arm 30 is a hollow tubular member, the connecting wires between the electronic components can be stored in the cavity of the arm 30, thereby avoiding the circuit from being exposed, and hence improving the completeness and service life.

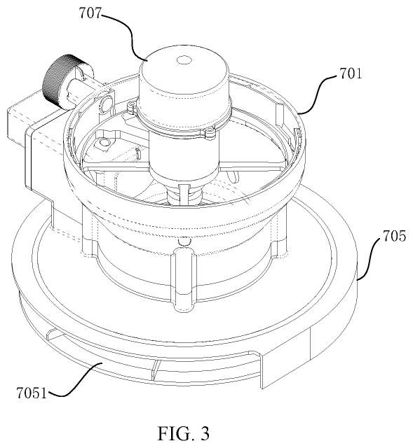

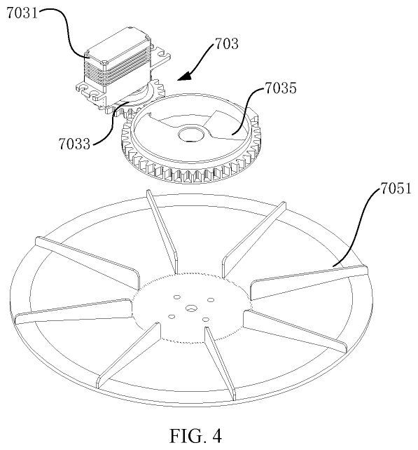

FIG. 3 is a schematic structural diagram of the spreading apparatus of the plant protection unmanned aerial vehicle, and FIG. 4 is a schematic structural diagram of an opening adjustment mechanism and a turntable of the spreading mechanism in FIG. 3. As shown in FIG. 3 and FIG. 4, the spreading apparatus 70 includes a material box 701, an opening adjustment mechanism 703 (also referred to as an “opening size adjustment mechanism”), a spreading mechanism 705, and a processor.

The material box 701 can be a box with a tapered or rectangular appearance, and boxes with other geometric shapes, e.g., irregularly-shaped boxes, are not excluded. A material inlet is provided at the top of the box, and solid materials (e.g., seeds, fish food, or pesticide, etc.) can be added to the box 701 from the material inlet. A material inlet cover is mounted at the top of the material inlet by a detachable connection such as snap-in or screwing, so that the material inlet cover can be removed during adding materials and re-attached after adding materials. A material outlet is provided at the bottom of the box, so that when the material outlet is opened, the material contained in the box can fall from the material outlet under the action of gravity.

In some embodiments, the material box 701 includes a stirring mechanism 707 for stirring materials. The stirring mechanism 707 includes a stirring motor, a transmission member, and one or more stirring rods. The output shaft of the stirring motor is fixed to the input end of the transmission member (e.g., a speed reducing gear), the output end of the transmission member is fixed to the stirring shaft, and one or more stirring rods are fixed to the stirring shaft. The shape of the stirring rod can be straight, arc, or any other suitable shape. When more than one stirring rod is provided, the stirring rods can be arranged along the axial or radial direction of the stirring shaft. Further, the more than one stirring rod can also be provided in the axial and radial directions of the stirring shaft at the same time to improve the stirring ability.

The stirring form of the stirring mechanism 707 may be arbitrary. In some embodiments, the stirring motor drives the stirring rod to reciprocate in an up-and-down direction through the transmission member (e.g., a driving gear provided at the output shaft of the stirring motor, and a toothed structure provided at the stirring shaft that meshes with the driving gear) to stir the material. In some embodiments, the stirring motor drives the stirring rod to rotate in a plane parallel to or inclined to a horizontal plane through the transmission member (e.g., a driving gear provided at the output shaft of the stirring motor, and a driven gear provided at the stirring shaft that meshes with the driving gear) to stir the material. When the stirring rod rotates in the plane inclined to the horizontal plane, it can provide additional force for the movement of the material in the direction of the material outlet to accelerate the material falling out of the material outlet. In some embodiments, the stirring motor can further drive the stirring rod along an irregular path through the transmission member (e.g., a transmission member similar to a three-axis gimbal) to stir the material, so that the material at any direction can be fully stirred. The transmission member may include a speed reducing element (e.g., multi-stage speed reducing gear) to reduce the speed transmitted to the stirring shaft.

In some embodiments, the stirring mechanism 707 can further include a duct disposed in the material box 701, and a fan disposed in the duct. A gap exists between the lower end of the duct and the bottom of the material box 701, and the direction of the airflow of the fan directly faces the bottom of the material box 701, so that the fan drives the air from the bottom of the duct to the material box 701 to achieve the stirring of the material. The material outlet at the bottom of the material box 701 should be away from the duct to allow a normal stirring by the ducted material stirring mechanism 707.

The opening adjustment mechanism 703 includes a steering gear 7031, a baffle plate, and a transmission member for drivingly connecting the steering gear 7031 and the baffle plate. The baffle plate and the steering gear 7031 can be provided below or above the material outlet, and the shape of the baffle plate matches the shape of the material outlet.

In some embodiments, the baffle plate can be designed as a circular baffle plate 7035 as shown in FIG. 4, and a toothed structure meshing with the transmission gear 7033 is provided at the outer edge of the circular baffle plate 7035. The transmission gear 7033 can be directly fixed at the output shaft of the steering gear 7031, or the transmission gear 7033 is connected to the output shaft of the steering gear 7031 through a multi-stage gear. The circular baffle plate 7035 is provided with an opening. When the degree of opening of the material outlet needs to be adjusted, the steering gear 7031 drives the circular baffle plate 7035 to rotate, thereby adjusting the size of the material discharge channel formed by the material outlet and the opening.

In some embodiments, the baffle plate can also be designed to be rectangular or fan-shaped, and the rectangular or fan-shaped baffle plate is hinged to the arm of the steering gear 7031 through a connection rod. When the degree of opening of the material outlet needs to be adjusted, the steering gear 7031 is started and the rotation shaft of the steering gear 7031 drives the arm of the steering gear to rotate. The arm of the steering gear drives the baffle plate to move in a straight direction or rotate through the connection rod, thereby partially or completely covering the material outlet, and hence changing the size of the discharge channel.

The baffle plate is driven by the steering gear 7031 to move, and information of a sensor of the steering gear 7031 can be directly read to obtain a real-time rotation angle of the rotation shaft of the steering gear 7031, so as to obtain the area of the material outlet currently shielded by the baffle plate, and hence obtain the real-time degree of opening of the material outlet and control the operation of the spreading apparatus 70.

In some embodiments, a servo motor is used instead of the steering gear 7031, the real-time rotation angle of the output shaft of the servo motor can also be obtained directly from the servo motor, so as to obtain the real-time degree of opening of the material outlet. In some other embodiments, a brushed motor or a brushless motor is used to replace the steering gear 7031, a sensor for measuring the output shaft of the motor is needed to obtain the real-time rotation angle of the motor.

Further, a stroke or distance of the arm of the steering gear or the baffle plate can be obtained through the sensor, to obtain the area of the material outlet currently shielded by the baffle plate. Specifically, as shown in FIG. 4, the baffle plate is the circular baffle plate 7035, and the area of the material outlet shielded by the baffle plate can be obtained by the rotation angle of the circular baffle plate 7035, so as to obtain the real-time degree of opening of the material outlet. When the material outlet and the baffle plate are both rectangular, the area of the material outlet shielded by the baffle plate can be obtained by the length of the movement of the baffle plate, so as to obtain the real-time degree of opening of the material outlet. When the material outlet and the baffle plate are both fan-shaped, the area of the material outlet shielded by the baffle plate can be obtained by the rotation angle of the connection rod that drives the baffle plate to rotate, so as to obtain the real-time degree of opening of the material outlet. The sensor configured to detect the rotation angle of the output shaft of the motor and the stroke or distance of the transmission member and the baffle plate can be any suitable sensor in the existing technologies, e.g., a Hall sensor, a laser sensor, or an infrared sensor.

In some embodiments, another transmission member, e.g., a gear/rack or a ratchet pawl, etc., can be used to perform transmission. For these alternative steering gear arms, the movement stroke or distance of one or more components thereof can also be detected through sensors, so as to perform real-time monitoring for the degree of opening of the material outlet.

The spreading mechanism 705 includes a turntable 7051 disposed below the material outlet, and a motor of the turntable 7051 that drives the turntable 7051 to rotate to throw the material out from the turntable 7051. In some embodiments, the upper surface of the turntable 7051 is provided with a plurality of convex edges along the radial direction to improve the spreading effect. The motor of the turntable 7051 can be connected to the turntable 7051 directly or through a transmission member, so as to drive the turntable 7051 to rotate in a substantially horizontal direction, so that the material falling from the material outlet to the turntable 7051 is thrown from the edge of the turntable 7051 onto a ground, water surface, or other fixed objects (e.g., trees, grass, etc.). When the rotation speed of the motor of the turntable 7051 is large and the rotation speed that the turntable 7051 needs is small, the transmission member may further include a speed reducing element to reduce the rotation speed of the motor of the turntable 7051.

The motor of the turntable 7051 can be any type of motor, e.g., a servo motor, a brush motor, or a brushless motor, etc. In order to accurately control the spreading process, the rotation speed of the turntable 7051 can be directly obtained through a rotation speed sensor, or indirectly obtained by obtaining a rotation angle of the motor. Specifically, when the rotation speed of the turntable 7051 is obtained indirectly through the rotation angle of the motor, if a servo motor is used, a processor to be described in detail below can be used to directly read the rotation angle or rotation speed data in the servo motor. If a brushed or brushless motor is used, a Hall sensor can be installed to obtain the rotation angle or speed of the brushed or brushless motor.

In some embodiments, in order to prevent the material from flying upward and impacting the material box 701 or the body 10 under the action of the centrifugal force, a baffle plate fixed or rotating coaxially with the turntable 7051 may be provided above the turntable 7051. In some embodiments, in order to control the material to be thrown out from the rear of the flight direction of the plant protection unmanned aerial vehicle, a side plate can be fixed at the bottom of the material box 701. A cavity is formed between the side plate and the turntable 7051 with an opening at the rear, and the material falling from the material outlet to the turntable can be thrown onto the ground, water surface or other fixed objects from the rear opening when the turntable 7051 rotates.

Further, when the stirring mechanism 707 stirs with a stirring rod, it can share one motor with the spreading mechanism 705. As shown in FIG. 3, the stirring rod of the stirring mechanism and the turntable 7051 of the spreading mechanism 705 can rotate coaxially by using a same motor disposed above the material box 701. Since the stirring speed and the spreading speed are generally different, the turntable 7051 or the stirring rod can be installed at the output shaft of the same motor through a speed reducing element.

In some embodiments, a processor includes at least a chip capable of executing a control method described below. Specifically, when the method is executed, the processor can perform an operation by calling an executable program in a memory, or through a logic operation circuit. It should be noted that when the processor executes the method, the processor can be execute the method in a background, or display to a user in a graphical interface, or execute the method partially in the background and display partially to the user. The processor can operate completely autonomously during the execution of the method, or the operation can be partially autonomous and partially with user participation.

The processor may be disposed at the material box 701, or in a remote controller, or integrated with the flight controller in the body 10, or installed in a server, and may be connected to the stirring mechanism 707, the opening adjustment mechanism 703, and the spreading mechanism 705 through wired or wireless communication. In some embodiments, the processor performs analysis and processing on obtained information, and performs linkage control on the opening adjustment mechanism 703 and the spreading mechanism 705 according to a result of the analysis and processing, thereby avoiding the issue of uneven spreading caused by the blocking of the material outlet by large particle size materials, and hence realizes an accurate control for the spreading operation.

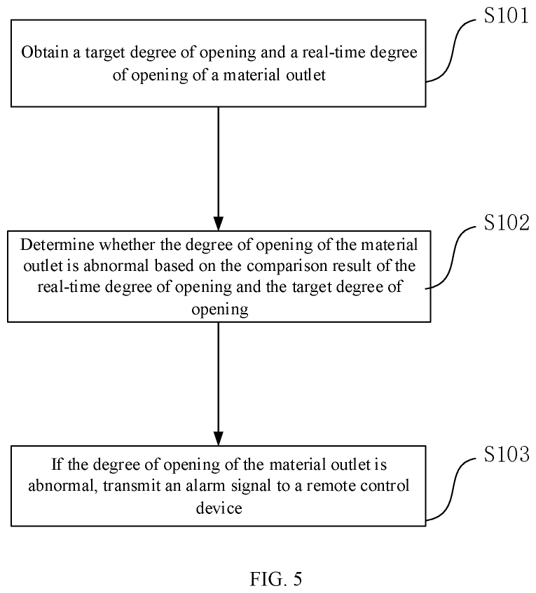

In some embodiments, a control method for the spreading apparatus 70 is described in detail taking an integration of the processor and the flight controller (referred to as “integrated flight controller”) as an example, with reference to the flowchart in FIG. 5. It should be noted that when the processor is separately disposed at the material box 701, in the remote controller, or in the server, the same control method can still be executed.

As shown in FIG. 5, the control method consistent with the disclosure includes the following.

At S101, a target degree of opening and a real-time degree of opening of the material outlet are obtained.

For the convenience of description, the following explanation will be given in the order of obtaining the target degree of opening of the material outlet and the real-time degree of opening of the material outlet. It should be noted that no order exists between obtaining the target degree of opening of the material outlet and obtaining the real-time degree of opening of the material outlet. That is, the target degree of opening of the material outlet can be obtained first, or the real-time degree of opening of the material outlet can be obtained first, or the target degree of opening and the real-time degree of opening of the material outlet can be obtained at the same time.

Various realizing methods can be used to obtain the target degree of opening of the material outlet. In some embodiments, the target degree of opening of the material outlet can be input by a user at a real time. Specifically, the user can input an instruction through an external input device (e.g., a remote control device), and the instruction is sent to the integrated flight controller via the input device, and the integrated flight controller reads the target degree of opening input by the user from the instruction.

In some embodiments, the target degree of opening of the material outlet can also be prestored in the memory of the integrated flight controller or an external storage. The integrated flight controller can read the database of the internal memory or external storage to obtain the target degree of opening. For example, a research institution or an agricultural service agency can store information of multiple materials in the server, where the information includes the name of each material, the particle size of each material, and the target degree of opening of the material outlet of each material. The integrated flight controller accesses the server and reads the database stored in the server to obtain the target degree of opening needed for the currently spread material. In some embodiments, a method such as sequential search, interpolation search, or binary search can be used for searching the target degree of opening in the database. As research institutions and agricultural service agencies have mastered a large number of new agricultural planting technologies, research can be conducted by these institutions to obtain an optimal spreading concentration of each material in different locations, and hence can improve agricultural production efficiency.

For example, it is determined through research and analysis by a research institution or agricultural service agency that when the material a is spread in areas A and B, the optimal degrees of opening of the material outlet are α1 and α2, respectively. A user issues a spreading plan to the plant protection unmanned aerial vehicle through a remote control device or an input device on the plant protection unmanned aerial vehicle. The integrated flight controller learns that the material a needs to be currently spread in the area A according to the spreading plan issued by the user, and reads and determines from the server of the research institute or agricultural service agency that the target degree of opening of the material outlet needed for the material a to be spread in the area A is α1. The integrated flight controller further controls the spreading apparatus according to the target degree of opening of the material outlet as α1. The spreading plan issued by the user can include the name of the material and the location, or only the name of the material. In some embodiments, when the spreading plan issued by the user only includes the name of the material without a spreading location, the plant protection unmanned aerial vehicle can obtain the real-time location information of the plant protection unmanned aerial vehicle according to a positioning device (e.g., a GPS or a Beidou navigation system) carried by the plant protection unmanned aerial vehicle. According to the name of the material in the spreading plan and the real-time location of the plant protection unmanned aerial vehicle obtained from the positioning device, the plant protection unmanned aerial vehicle can obtain the target degree of opening of the material outlet needed for the material to be spread in the real-time location of the plant protection unmanned aerial vehicle from the server of the research institution or agricultural service agency. For example, when the spreading plan is the material a, and the real-time location of the plant protection unmanned aerial vehicle obtained by the positioning device is location A, then the target degree of opening of the material outlet is α1.

Further, if the spreading plan of the plant protection unmanned aerial vehicle is spreading the material a, and the spreading area includes A and B, then when the positioning device of the plant protection unmanned aerial vehicle detects that the plant protection unmanned aerial vehicle has flown from the area A to the area B, the integrated flight controller can adjust the target degree of opening of the material outlet from α1 to α2 according to the positioning information detected by the positioning device. When different materials are spread in the area A and the area B, the target degree of opening of the material outlet can also be adjusted in real time according to the positioning information of the positioning device.

Obtaining the real-time degree of opening of the material outlet includes obtaining an operation parameter of the opening adjustment mechanism for adjusting the size of the material outlet, and obtaining the real-time degree of opening of the material outlet according to the operation parameter. Specifically, the operation parameter may include, e.g., the rotation angle of the motor in the opening adjustment mechanism, the stroke of the transmission member that connects the motor and the baffle plate, the stroke of the baffle plate provided at the material outlet to adjust the degree of opening of the material outlet, or the angle of the baffle plate. The motor includes but is not limited to, a steering gear, a brush motor, a brushless motor, or a servo motor. The transmission member includes but is not limited to, a connection rod (e.g., a two-link rod consisting of a steering gear arm and a connection rod), a gear, or a lead screw. The baffle plate includes but is not limited to a rectangular baffle plate or an arc baffle plate.

Specifically, after the real-time rotation angle of the motor is obtained, the stroke or distance of the baffle plate can be calculated according to the angle, and the area of the material outlet shielded by the baffle plate can be determined, and hence the real-time degree of opening of the material outlet can be obtained. If the change of the rotation angle of the motor is equal to the change of the degree of opening of the material outlet, the degree of opening of the material outlet can be directly expressed by the rotation angle of the motor, that is, the real-time degree of opening of the material outlet is equal to the real-time rotation angle of the motor. In another embodiment, after the stroke of the transmission member is obtained, the stroke or distance of the baffle plate can be calculated according to the stroke, and the area of the material outlet shielded by the baffle plate can be determined, and hence the real-time degree of opening of the material outlet can be obtained.

The method and formula for calculating above described stroke or distance of the baffle plate according to the angle or the stroke of the transmission member can be referred to existing technologies, and are omitted here. After the stroke or distance of the baffle plate is obtained, and the area of the material outlet shielded by the baffle plate can be determined, and hence the real-time degree of opening of the material outlet can be obtained.

At S102, whether the degree of opening of the material outlet is abnormal is determined on the basis of a comparison result of the real-time degree of opening and the target degree of opening.

Specifically, when the real-time degree of opening is equal to the target degree of opening, it is considered that the degree of opening of the material outlet is normal, and the plant protection unmanned aerial vehicle executes the spreading operation according to a normal procedure. On the other hand, when the real-time degree of opening is larger or smaller than the target degree of opening, it is considered that the degree of opening of the material outlet is abnormal.

It is noted that, since the target degree of opening can be input by the user through the remote control device or read in a data list of the database, and the real-time degree of opening is obtained through the parameter of the opening adjustment mechanism 703 (e.g., the real-time rotation angle of the motor, the stroke of the transmission member, or the stroke, distance, or area of the baffle plate, etc.) collected by a sensor, the parameter may differ from the obtained target degree of opening in terms of expression form. For example, if the target degree of opening indicates the percentage of the part not shielded by the baffle plate in the whole material outlet, and the real-time degree of opening is obtained by collecting the rotation angle of the motor, the rotation angle of the motor obtained by the integrated flight controller cannot be directly compared with the target degree of opening. In some embodiments, the formats of the target degree of opening and the real-time degree of opening need to be unified. For example, in the example described above, the obtained rotation angle of the motor needs to be converted to the percentage of the opening of the material outlet, or the target degree of opening needs to be converted to the rotation angle of the motor before the comparison. On the other hand, if the target degree of opening obtained indicates an expected rotation angle of the motor, then when the real-time degree of opening is also obtained by collecting the rotation angle of the motor, the target degree of opening and the real-time degree of opening are consistent in the form of expression and can be directly compared without conversion.

At S103, an alarm signal is transmitted to the remote control device when the degree of opening of the material outlet is abnormal.

In some embodiments, the remote control device is provided with an indicator light. When the integrated flight controller detects that the degree of opening of the material outlet is abnormal, it transmits an alarm signal to the remote control device to control the indicator light on/off or flashing.

In some embodiments, the remote control device is provided with a buzzer. When the integrated flight controller detects that the degree of opening of the material outlet is abnormal, the integrated flight controller transmits an alarm signal to the remote control device to control the buzzer to play a voice prompt message that is prestored in the memory of the remote control device.

In some embodiments, the remote control device is provided with a display screen. When the integrated flight controller detects that the degree of opening of the material outlet is abnormal, it transmits an alarm signal to the remote control device to control the display screen to display a text prompt message (e.g., “The opening of the material outlet is abnormal”) that is prestored in the memory of the remote control device.

In some embodiments, an indicator light, a buzzer, and a display screen can all be provided, or any two of them can be provided.

As described above, with the target degree of opening and the real-time degree of opening of the material outlet, it can be determined whether the degree of opening of the material outlet is abnormal based on the comparison result of the two. When the degree of opening of the material outlet is abnormal, an alarm signal is transmitted to the remote control device for the user to grasp the information of the abnormal degree of opening of the material outlet in time. A targeted measure can be further taken according to different cases of abnormal degree of opening to ensure that the spreading uniformity is not affected by the abnormal degree of opening.

Value of the target degree of opening, value of the real-time degree of opening, and the comparison result of the two have various scenarios, that is, there are many different scenarios where the degree of opening of the material outlet is abnormal. The following describes the control process of several possible scenarios in detail for a better understanding of the spreading apparatus control method. It should be noted that, other methods of analyzing the target degree of opening and the real-time degree of opening, and controlling the spreading operation of the plant protection unmanned aerial vehicle according to the analysis result to avoid uneven spreading are also within the scope of the disclosure.

For example, when the real-time degree of opening is greater than zero and less than the target degree of opening, an alarm signal that the opening is too small is transmitted to the remote control device. Specifically, the user can be warned by the on/off or flashing of an indicator light provided at the remote control device, or the user can be warned by a voice prompt message played through a buzzer, or the user can be warned visually by a text prompt message (e.g., “The opening is too small,” etc.) displayed on a display screen, so that the user can grasp the situation of the opening adjustment mechanism in time, and hence the integrated flight controller or the user can take measures targeting the abnormal situation.

In some embodiments, when the alarm signal that the opening is too small is transmitted to the remote control device, the material outlet of the spreading apparatus can be controlled to close. For example, the integrated flight controller receives a control instruction sent by the remote control device, and sends an instruction to close the material outlet to the opening adjustment mechanism according to the control instruction, so as to control the motor of the opening adjustment mechanism to start and drive the baffle plate provided at the material outlet to move to close the material outlet. In another embodiment, the integrated flight controller generates a control instruction to control the opening adjustment mechanism to send an instruction to close the material outlet, so as to control the motor of the opening adjustment mechanism to start and drive the baffle plate to move. By closing the material outlet of the spreading apparatus, the spreading operation can be stopped, thereby preventing uneven spreading.

Further, when the material outlet of the spreading apparatus is controlled to be closed, any one or more of the following operations may be executed: controlling the turntable of the spreading apparatus to stop rotating, and controlling the plant protection unmanned aerial vehicle provided with the spreading apparatus to return. Specifically, an instruction for stopping the rotation of the turntable and controlling the plant protection unmanned aerial vehicle to return may also be sent by the user to the integrated flight controller through the remote control device, or the integrated flight controller may generate a control instruction by itself. Energy can be saved by controlling the turntable to stop rotating, and controlling the plant protection unmanned aerial vehicle to return can prevent the unmanned aerial vehicle from continuing to fly along the path of the spreading operation when the spreading operation is not being performed.

In some embodiments, when the alarm signal that the opening is too small is transmitted to the remote control device, the flight speed of the plant protection unmanned aerial vehicle can be reduced, so that the real-time degree of opening of the material outlet matches the flight speed of the plant protection unmanned aerial vehicle. The spreading operation can be continued. At the same time, it can be ensured that the uniformity of a subsequent spreading operation is consistent with the uniformity of a previous spreading operation or the uniformity of a scheduled spreading operation, thereby reducing the impact on the spreading operation due to the small real-time degree of opening of the material outlet.

As another example, when the target degree of opening is greater than zero and less than the real-time degree of opening, an alarm signal that the opening is too large is transmitted to the remote control device. Specifically, the user can be warned by the on/off or flashing of an indicator light provided at the remote control device, or the user can be warned by a voice prompt message played through a buzzer, or the user can be warned visually by a text prompt message (e.g., “The opening is too large,” etc.) displayed on a display screen, so that the user can grasp the situation of the opening adjustment mechanism in time, and hence the integrated flight controller or the user can take measures targeting the abnormal situation.

In some embodiments, when the alarm signal that the opening is too large is transmitted to the remote control device, the material outlet of the spreading apparatus is also controlled to close. For example, the integrated flight controller receives a control instruction sent by the remote control device, and sends an instruction to close the material outlet to the opening adjustment mechanism according to the control instruction, so as to control the motor of the opening adjustment mechanism to start and drive the baffle plate provided at the material outlet to move to close the material outlet. In another embodiment, the integrated flight controller generates a control instruction to control the opening adjustment mechanism to send an instruction to close the material outlet, so as to control the motor of the opening adjustment mechanism to start and drive the baffle plate to move. By closing the material outlet of the spreading apparatus, the spreading operation can be stopped, thereby preventing uneven spreading.

Further, when the material outlet of the spreading apparatus is controlled to be closed, any one or more of the following operations may be executed: controlling the turntable of the spreading apparatus to stop rotating, and controlling the plant protection unmanned aerial vehicle provided with the spreading apparatus to return. Specifically, an instruction for stopping the rotation of the turntable and controlling the plant protection unmanned aerial vehicle to return may also be sent by the user to the integrated flight controller through the remote control device, or the integrated flight controller may generate a control instruction by itself. Energy can be saved by controlling the turntable to stop rotating, and controlling the plant protection unmanned aerial vehicle to return can prevent the unmanned aerial vehicle from continuing to fly along the path of the spreading operation when the spreading operation is not performed.

In some embodiments, when the alarm signal that the opening is too large is transmitted to the remote control device, the flight speed of the plant protection unmanned aerial vehicle can be increased, so that the real-time degree of opening of the material outlet matches the flight speed of the plant protection unmanned aerial vehicle. The spreading operation can continues. At the same time, it can be ensured that the uniformity of a subsequent spreading operation is consistent with the uniformity of a previous spreading operation or the uniformity of a scheduled spreading operation, thereby reducing the impact on the spreading operation due to the large real-time degree of opening of the material outlet.

As a further example, when the target degree of opening is greater than zero and the real-time degree of opening is always equal to zero within a first preset time, an alarm signal that the opening cannot be opened is transmitted to the remote control device. Specifically, the user can be warned by the on/off or flashing of an indicator light provided at the remote control device, or the user can be warned by a voice prompt message played through a buzzer, or the user can be warned visually by a text prompt message (e.g., “The opening cannot be opened,” etc.) displayed on a display screen, so that the user can grasp the situation of the opening adjustment mechanism in time, and hence the integrated flight controller or the user can take measures targeting the abnormal situation.

Further, when the alarm signal that the opening cannot be opened is transmitted to the remote control device, any one or more of the following operations may be executed: controlling the turntable of the spreading apparatus to stop rotating, and controlling the plant protection unmanned aerial vehicle provided with the spreading apparatus to return. Specifically, an instruction for stopping the rotation of the turntable and controlling the plant protection unmanned aerial vehicle to return may also be sent by the user to the integrated flight controller through the remote control device, or the integrated flight controller may generate a control instruction by itself. Energy can be saved by controlling the turntable to stop rotating, and controlling the plant protection unmanned aerial vehicle to return can prevent the unmanned aerial vehicle from continuing to fly along the path of the spreading operation when the spreading operation is not performed. In some embodiments, the turntable is controlled to stop rotating and the plant protection unmanned aerial vehicle is controlled to return.

As a further example, when the target degree of opening is equal to zero and the real-time degree of opening is always greater than zero within a preset time, an alarm signal that the opening cannot be closed is transmitted to the remote control device. Specifically, the user can be warned by the on/off or flashing of an indicator light provided at the remote control device, or the user can be warned by a voice prompt message played through a buzzer, or the user can be warned visually by a text prompt message (e.g., “The opening cannot be closed,” etc.) displayed on a display screen, so that the user can grasp the situation of the opening adjustment mechanism in time, and hence the integrated flight controller or the user can take measures targeting the abnormal situation.

Further, when transmitting the alarm signal that the opening cannot be closed to the remote control device, any one or more of the following operations may be executed: controlling the turntable of the spreading apparatus to stop rotating, and controlling the plant protection unmanned aerial vehicle provided with the spreading apparatus to return. Specifically, an instruction for stopping the rotation of the turntable and controlling the plant protection unmanned aerial vehicle to return may also be sent by the user to the integrated flight controller through the remote control device, or the integrated flight controller may generate a control instruction by itself. By controlling the turntable to stop rotating, although the material can still fall from the material outlet to the turntable, the material falling on the turntable will not be spread to the field to ensure the uniformity of the spreading. Controlling the plant protection unmanned aerial vehicle to return can prevent the unmanned aerial vehicle from continuing to fly along the path of the spreading operation when the spreading operation is not performed. In some embodiments, when the material outlet cannot be closed, controlling the turntable to stop rotating and controlling the plant protection unmanned aerial vehicle to return can prevent the material from being thrown out or overflowing from the turntable.

When the integrated flight controller controls the movement of the baffle plate to open or close the material outlet, the baffle plate needs a period of time to execute the instruction of the integrated flight controller. In order to avoid a false alarm during this period, the integrated flight controller may not transmit the alarm signal to the remote control device during this period. For example, when the spreading apparatus is started, it takes an initialization time to start the turntable and control the turntable to accelerate, and control the movement of the baffle plate to open the material outlet. During this initialization time, the integrated flight controller does not transmit an alarm signal to the remote control device. A response time also exists when the spreading apparatus is shut down and the integrated flight controller does not transmit an alarm signal to the remote control device during this response time. It is noted that the first preset time described above should be greater than or equal to the initialization time at startup, and the second preset time described above should be greater than or equal to the response time at shutdown.

Further, when the degree of opening of the material outlet is not abnormal in which case the plant protection unmanned aerial vehicle performs spreading operation according to a normal procedure, or although the degree of opening of the material outlet is too small/too large, the spreading operation is performed by adjusting the flight speed (deceleration or acceleration) of the plant protection unmanned aerial vehicle, if an instruction to close the material outlet is received from the remote control device, a control instruction is sent to the opening adjustment mechanism to control the movement of the baffle plate of the opening adjustment mechanism to close the material outlet. Whether the degree of opening of the material outlet is gradually becoming zero is also detected, and if not, an alarm signal that the opening cannot be closed is transmitted to the remote control device, and the turntable of the spreading apparatus is controlled to stop rotating, when the plant protection unmanned aerial vehicle can be further controlled to return.

The acquisitions of the target degree of opening and the real-time degree of opening of the material outlet when the plant protection unmanned aerial vehicle is performing the spreading operation are described, analyzed and compared above. Based on the comparison result, the degree of opening of the material outlet, the turntable being on/off, the flight speed of the plant protection unmanned aerial vehicle, and the flight direction of the plant protection unmanned aerial vehicle are controlled, so as to avoid the issue that the spreading uniformity is affected by the abnormal degree of opening of the material outlet caused by material blocking or mechanical failure during the spreading operation. The processor may execute the method through an executable program or an integrated circuit.

In addition, the terms “first” and “second,” etc. in the method embodiments do not indicate an order or quantity of the operations, and are merely for convenience of description. The term “real-time” can refer to “current moment”.

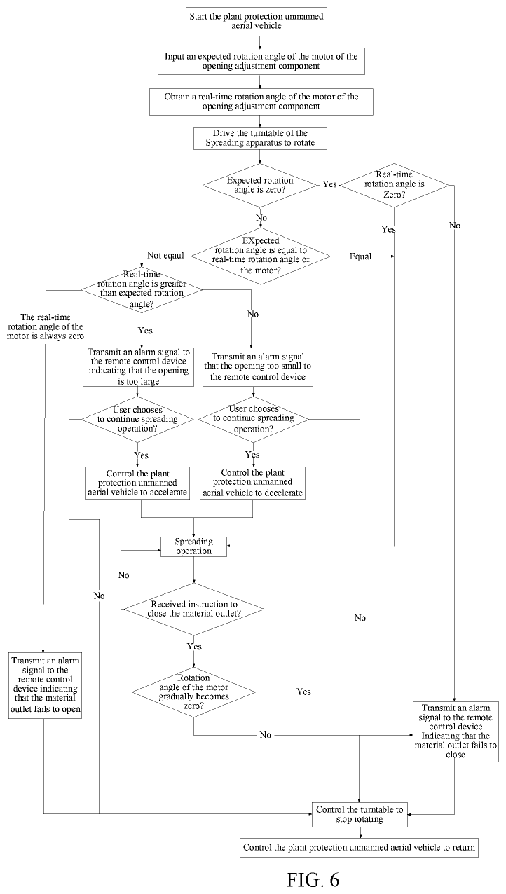

A specific control method that can be used in the spreading operation of the plant protection unmanned aerial vehicle is described below with reference to FIG. 6, where the opening adjustment mechanism of the spreading apparatus of the plant protection unmanned aerial vehicle is provided with a motor as the power source, and the rotation angle of the motor is equal to the rotation angle of the baffle plate, that is, the real-time rotation angle of the motor is equal to the real-time degree of opening of the material outlet.

As shown in FIG. 6, the plant protection unmanned aerial vehicle is started, and an expected rotation angle of the motor of the opening adjustment mechanism (i.e., a target degree of opening) is input to the plant protection unmanned aerial vehicle through the remote controller. A real-time rotation angle of the motor is then obtained. At the same time, the spreading apparatus is started to drive the turntable in the spreading apparatus to rotate.

If the expected rotation angle of the motor is equal to zero and the real-time rotation angle of the motor is not equal to zero, an alarm signal that the opening cannot be closed is transmitted to the remote control device, and the turntable is controlled to stop rotating and the plant protection unmanned aerial vehicle is controlled to return.

If the expected rotation angle of the motor is equal to zero and the real-time rotation angle of the motor is equal to zero, or if the expected rotation angle of the motor is not zero and equal to the real-time rotation angle of the motor, the spreading operation is executed.

If the expected rotation angle of the motor is not zero and is greater than the real-time rotation angle of the motor, an alarm signal that the opening is too small is transmitted to the remote control device, and a follow-up operation is executed according to an instruction sent by the operator through the remote control device, e.g., reducing the flight speed of the plant protection unmanned aerial vehicle and performing spreading operation, or controlling the turntable to stop rotating and controlling the plant protection unmanned aerial vehicle to return.

If the expected rotation angle of the motor is not zero and is smaller than the real-time rotation angle of the motor, an alarm signal that the opening is too large is transmitted to the remote control device, and a follow-up operation is executed according to an instruction sent by the operator through the remote control device, e.g., increasing the flight speed of the plant protection unmanned aerial vehicle and performing spreading operation, or controlling the turntable to stop rotating and controlling the plant protection unmanned aerial vehicle to return.

During the spreading operation, if an instruction to close the material outlet input by the user through the remote control device or sent by the integrated flight controller is received, whether the rotation angle of the motor is gradually becoming zero is detected. When the rotation angle of the motor is gradually becoming zero, the turntable is controlled to stop rotating and the plant protection unmanned aerial vehicle is controlled to return. When the rotation angle of the motor does not become zero, an alarm signal that the opening cannot be closed is transmitted to the remote control device, the turntable is controlled to stop rotating and the plant protection unmanned aerial vehicle is controlled to return.

If the expected rotation angle of the motor is not zero and the real-time rotation angle of the motor is always zero, an alarm signal that the opening cannot be opened is transmitted to the remote control device, and the turntable is controlled to stop rotating and the plant protection unmanned aerial vehicle is controlled to return.

The advantages associated with some embodiments have been described in this specification, but other embodiments may also include these advantages, and not all embodiments describe all advantages of the disclosure in detail. The advantages objectively brought by the technical features in the embodiments should be regarded as the advantages of the present disclosure, and should all fall within the scope of the present disclosure.

What is claimed is:

1. A method for controlling a spreading apparatus comprising:
obtaining a target degree of opening and a real-time degree of opening of a material outlet of the spreading apparatus;
determining whether the real-time degree of opening of the material outlet is abnormal based on a comparison result between the real-time degree of opening and the target degree of opening; and
transmitting, in response to the real-time degree of opening of the material outlet being abnormal, an alarm signal to a remote control device.

2. The method of claim 1, further comprising:
controlling the material outlet of the spreading apparatus to close while the alarm signal is being transmitted to the remote control device.

3. The method of claim 2, further comprising, while controlling the material outlet of the spreading apparatus to close:
controlling a turntable of the spreading apparatus to stop rotating;
controlling a plant protection unmanned aerial vehicle carrying the spreading apparatus to return; or
controlling the turntable of the spreading apparatus to stop rotating and the plant protection unmanned aerial vehicle provided with a spreading apparatus to return at the same time.

4. The method of claim 2, wherein controlling the material outlet to close includes:
receiving a control instruction sent by the remote control device; and
controlling the material outlet to close according to the control instruction.

5. The method of claim 1, further comprising, while transmitting the alarm signal to the remote control device:
changing a flight speed of a plant protection unmanned aerial vehicle carrying the spreading apparatus.

6. The method of claim 5, wherein changing the flight speed of the plant protection unmanned aerial vehicle includes:
receiving a control instruction sent by the remote control device; and
controlling the plant protection unmanned aerial vehicle to accelerate or decelerate according to the control instruction.

7. The method of claim 1, wherein obtaining the target degree of opening of the material outlet includes:
receiving the target degree of opening sent by the remote control device; or
reading the target degree of opening from a database.

8. The method of claim 1, wherein obtaining the real-time degree of opening of the material outlet includes:
obtaining an operation parameter of an opening adjustment mechanism that is configured to adjust a size of the material outlet; and
obtaining the real-time degree of opening according to the operation parameter.

9. The method of claim 8, wherein:
the opening adjustment mechanism includes a motor, a baffle plate provided at the material outlet and configured to adjust the size of the material outlet, and a transmission member configured to transmissively connect the motor and the baffle plate; and
the operation parameter of the opening adjustment mechanism includes a rotation angle of the motor, a stroke of the transmission member, a stroke of the baffle plate, or a rotation angle of the baffle plate.

10. The method of claim 9, wherein the real-time rotation angle of the motor is equal to the real-time degree of opening of the material outlet.

11. The method of claim 1, further comprising, while transmitting the alarm signal to the remote control device:
controlling a plant protection unmanned aerial vehicle carrying the spreading apparatus to return; or
controlling a turntable of the spreading apparatus to stop rotating.

12. The method of claim 1, further comprising, while transmitting the alarm signal to the remote control device:
controlling a plant protection unmanned aerial vehicle carrying the spreading apparatus to return while controlling a turntable of the spreading apparatus to stop rotating.

13. The method of claim 1, wherein transmitting the alarm signal to the remote control device includes:
transmitting, in response to the real-time degree of opening being greater than zero and less than the target degree of opening, an alarm signal indicating that the opening is too small to the remote control device.

14. The method of claim 1, wherein transmitting the alarm signal to the remote control device includes:
transmitting, in response to the target degree of opening being greater than zero and less than the real-time degree of opening, an alarm signal indicating that the opening is too large to the remote control device.

15. The method of claim 1, wherein transmitting the alarm signal to the remote control device includes:
transmitting, in response to the target degree of opening being greater than zero and the real-time degree of opening being equal to zero within a preset time, an alarm signal indicating that the material outlet fails to open to the remote control device.

16. The method of claim 1, wherein transmitting the alarm signal to the remote control device includes:
transmitting, in response to the target degree of opening being equal to zero and the real-time degree of opening being greater than zero within a preset time, an alarm signal indicating that the material outlet fails to close to the remote control device.

17. The method of claim 1, further comprising:
receiving an instruction to close the material outlet;
controlling an opening adjustment mechanism of the spreading apparatus to close the material outlet according to the instruction;
detecting whether the real-time degree of opening of the material outlet is gradually becoming zero; and
in response to the real-time degree of opening of the material outlet not gradually becoming zero, transmitting an alarm signal indicating that the material outlet fails to close to the remote control device.

18. A spreading apparatus comprising:
a material box including a material outlet at bottom;
an opening adjustment mechanism including a baffle plate provided at the material outlet, and a baffle plate motor configured to drive the baffle plate to move to adjust a degree of opening of the material outlet;
a spreading mechanism including a turntable provided below the baffle plate, and a turntable motor configured to drive the turntable to rotate; and
a processor configured to:
obtain a target degree of opening and a real-time degree of opening of the material outlet;
determine whether the real-time degree of opening of the material outlet is abnormal based on a comparison result between the real-time degree of opening and the target degree of opening; and
transmit, in response to the real-time degree of opening of the material outlet being abnormal, an alarm signal to a remote control device.

19. A plant protection unmanned aerial vehicle comprising:
a body;
an arm, one end of the arm being connected with the body;
a power assembly arranged at another end of the arm; and
a spreading apparatus carried below the body and including:
a material box including a material outlet at bottom;
an opening adjustment mechanism including a baffle plate provided at the material outlet, and a baffle plate motor configured to drive the baffle plate to move to adjust a degree of opening of the material outlet;
a spreading mechanism including a turntable provided below the baffle plate, and a turntable motor configured to drive the turntable to rotate; and
a processor configured to:
obtain a target degree of opening and a real-time degree of opening of the material outlet;
determine whether the real-time degree of opening of the material outlet is abnormal based on a comparison result between the real-time degree of opening and the target degree of opening; and
transmit, in response to the real-time degree of opening of the material outlet being abnormal, an alarm signal to a remote control device.

20. The plant protection unmanned aerial vehicle of claim 19, wherein the processor of the spreading apparatus is integrated with a flight controller disposed inside the body.

21. The plant protection unmanned aerial vehicle of claim 20, further comprising:
the remote control device in communication connection with the flight controller.
